(19) United States
(12) Patent Application Publication
(10) Pub. No.: US 2026/0275964 A1
(43) Pub. Date: Sep. 17, 2026

(54) Method for a Wind Farm

(71) Applicant: Jan-Bernd Franke, Elmshorn (DE)

(72) Inventor: Jan-Bernd Franke, Elmshorn (DE)

(73) Assignee: RWE Offshore Wind GmbH, Essen (DE)

(21) Appl. No.: 19/674,622

(22) Filed: May 12, 2026

Related U.S. Application Data
(63) Continuation of application No. PCT/EP2024/080422, filed on Oct. 28, 2024.

(30) Foreign Application Priority Data
Dec. 1, 2023 (DE) 10 2023 133 670.3

(51) Int. Cl. F03D 17/00

(52) U.S. Cl. CPC F03D 17/007; F03D 17/006; F03D 17/012; F05B 2260/80; F05B 2260/84

(57) ABSTRACT

A computer-implemented method, for a wind farm, comprising determining an actual remaining service life time of a first wind turbine of the wind farm based on a model of at least one reference wind turbine and on a first operating data set of the first wind turbine, comparing the determined actual remaining service life time of the first wind turbine with a predetermined remaining service life time of the first wind turbine, and performing a performance adjustment of a predefined performance framework of the first wind turbine for a defined future period, such that the actual remaining service life time of the first wind turbine is brought into alignment with the specified remaining service life time of the first wind turbine, upon detecting a predefinable deviation between the actual remaining service life time of the first wind turbine and the specified remaining service life time of the first wind turbine.

### CROSS-REFERENCE TO RELATED PATENT APPLICATIONS

This patent application is a continuation of International Application No. PCT/EP2024/080422, filed on Oct. 28, 2024, which claims the benefit of priority to German Patent Application No. 10 2023 133 670.3, filed Dec. 1, 2023, the entire teachings and disclosures of both applications are incorporated herein by reference thereto.

### FIELD OF THE INVENTION

The invention relates to a method, in particular, a computer-implemented method, for a wind farm. Furthermore, the invention relates to a computing device and a wind farm.

### BACKGROUND OF THE INVENTION

Nowadays, electrical energy is increasingly generated using renewable energy sources. Thus, (onshore and/or offshore) wind farms are installed with at least one wind turbine. Furthermore, a wind farm may comprise additional structures, such as a substation, a measuring station, etc. A wind turbine is configured to convert wind energy, that is, the kinetic energy of moving air, into electrical energy.

Typically, a wind turbine is formed by a foundation structure, a tower, and a nacelle mounted on the tower. The wind energy is converted into electrical energy by means of a rotor, a drive train, a generator, and similar components.

In order to ensure a safe operation, a wind turbine typically features a corresponding SCADA system (Supervisory Control and Data Acquisition), which implements the operational management and safety concept, records operating data, and is used for control purposes. Structural Health Monitoring (SHM) systems may also be used to monitor the foundation structures. SCADA and SHM systems can be integrated and provide the operating data sets. If multiple wind turbines are operated in a wind farm, the SCADA systems of the wind turbines are typically connected to a higher-level wind farm control and operational management system.

A wind turbine is subjected to high (mechanical) stresses after installation and during operation. These stresses result in a finite service life time for every wind turbine. This is due, in particular, to fatigue damage in defined (non-repairable or non-replaceable) components of a wind turbine. These components are also referred to as load-bearing structural components (e.g., tower, nacelle, foundation, etc.).

In practice, such structural components of a wind turbine cannot be replaced with spare parts or repaired. This means, in particular, that replacing or repairing of such a component is not carried out in practice for cost reasons compared to installing a new wind turbine, even if it would be theoretically possible.

Due to the natural fluctuation of wind speeds over the course of a year, wind turbines are designed for statistically representative wind speeds defined in so-called type classes or wind classes. The key design wind characteristics for wind turbines are the average wind speed and turbulence intensity. During operation, these wind characteristics are subject to seasonal and multi-year fluctuations.

Nowadays, wind turbines, in particular, offshore wind turbines, are designed for a defined respectively predefined service life time (e.g., 20 years). In other words, a wind turbine is designed such that the technical life respectively actual service life time essentially corresponds to (and, as a rule, exceeds for safety reasons) the predefined service life time of the wind turbine.

In order to further ensure that the technical service life time actually corresponds to the predefined service life time (i.e., that no damage to the structural components occurs before the end of the predefined service life time), a performance framework is also strictly defined for the respective wind turbine. In particular, the performance framework for a respective wind turbine predefines at least one (maximum permissible) performance parameter limit value that must not be exceeded during the operation of the wind turbine.

In the prior art, when designing a wind turbine it is generally assumed that the wind turbine will be operated continuously throughout its predefined service life time at the at least one performance parameter limit value predefined in the performance framework (e.g., a predefined rated power). It is assumed that the wind characteristics do not change during the operational phase and remain within the design wind characteristics. However, it has been observed during operation that years with strong and weak winds can occur resulting in correspondingly different energy yields. Even when averaged over several years, the actual wind conditions generally fall short of the design wind characteristics, as the wind conditions at the respective wind farm sites are within or below the type classes respectively wind classes.

It has been recognized that, in practice, the technical service life time of a wind turbine generally exceeds its predefined service life time. For example, the actual frequency of loads on a wind turbine is lower in practice, as maintenance work or requirements from a grid operator of an external power grid to which the wind farm is connected or periods of low wind speeds result in times when a wind turbine is not operated within the range of at least one performance parameter limit, but may even be shut down.

Nevertheless, it is defined in the prior art that a wind turbine is always deinstalled after reaching its predefined service life time. Only in a few exceptional cases operation can be continued for a limited period in compliance with the performance parameter limit values. A disadvantage of this is that the electrical power and electrical energy, respectively, that a wind turbine could in principle generate during its technical service life time is not achieved within the predefined service life time of the wind turbine. In other words, the energy yield of a wind turbine during its predefined service life time is generally reduced compared to the energy yield that could in principle be achieved by that wind turbine.

Typically, a wind farm is formed by several wind turbines that have a uniform technical life time. During the planning phase, the operational life time of the wind farm is equated with the technical life time of the defined type of wind turbine used. However, it has been observed that during the operational phase, the various wind turbines experience different operating conditions, such as wind, external curtailment by grid operators, and downtime due to maintenance, which lead to varying degrees of aging among the individual wind turbines in the wind farm. Upon reaching the technical service life time, the respective wind turbine is generally taken out of service, provided that the remaining service life time assessment does not permit safe continued operation. The infrastructure required for operation, e.g., ships, control rooms, operating crews, maintenance contracts, and the associated costs remain in place for a now reduced number of wind turbines. This reduces the economic efficiency of the wind farm and increases the specific electricity generation costs. The ideal economic scenario is when all wind turbines in a wind farm reach the end of their technical service life time at the same time.

### SUMMARY OF THE INVENTION

Therefore, the object of the invention is to provide a possibility to at least reduce the disadvantages of the prior art and, in particular, to increase the achievable energy yield of a wind turbine during the predefined service life time of that wind turbine. Furthermore, the method is intended to be used to align the service life time consumption of all wind turbines in a wind farm throughout the entire operational phase in such a way that the service life time of the entire wind farm corresponds as closely as possible to the respective service life time consumption of the individual wind turbines.

The object is solved, according to a first aspect of the invention, by a method according to claim 1. The method is, in particular, a computer-implemented method. The method is intended for use in a wind farm, in particular, in an offshore wind farm. The method comprises:
determining an actual remaining service life time of a first wind turbine of the wind farm based on a model of at least one reference wind turbine (of the wind farm) and on at least one first operating data set of the first wind turbine,
comparing the determined actual remaining service life time of the first wind turbine with a predefined remaining service life time of the first wind turbine, and
performing a performance adjustment of a predefined performance framework of the first wind turbine for a defined future period such that the actual remaining service life time of the first wind turbine is aligned with the predefined remaining service life time of the first wind turbine, upon detecting a predefinable deviation between the actual remaining service life time of the first wind turbine and the predefined remaining service life time of the first wind turbine.

A further aspect of the invention is a computing device comprising at least one data storage, containing computer program code, and at least one processor, wherein the data storage and the processor are configured such that the computing device is caused to perform the method described above.

According to the invention, the method constitutes, in particular, an extension of the operational management and safety concept of the wind turbine. The method is preferably implemented either individually on each wind turbine or at the level of a wind farm control and operational management.

In contrast to the prior art, according to the invention by providing a method in which the actual remaining service life time is first determined for at least one (installed) first wind turbine, then this actual remaining service life time is compared with the predefined remaining service life time of this wind turbine, and then, depending on the result of the comparison, at least one performance parameter (limit) value of a predefined performance framework is adjusted, the disadvantages of the prior art are at least reduced and, in particular, the achievable energy yield during the predefined service life time and usable life time, respectively, of this wind turbine is increased. In particular, it has been recognized that by modifying the performance framework-a modification not conceivable in the prior art-such as the defined rated power of the wind turbine, the actual remaining service life time of this wind turbine can be adapted to the predefined remaining service life time of this wind turbine.

The adjustment of the performance framework of a wind turbine may comprise an adjusting of the orientation of the nacelle relative to the wind direction, in particular, to align the actual remaining service life time with the predefined remaining service life time. This can be, in particular, relevant in a so-called spin mode to increase aeroelastic damping and thereby reduce life time shortening structural vibrations caused by resonance phenomena. Furthermore, adjusting the orientation of the nacelle relative to the wind direction can be used in such a way that, while the actual remaining service life time of this wind turbine is reduced, this is done to improve the flow conditions for a neighboring wind turbine in the wind farm, thereby increasing its energy yield and aligning its actual remaining service life time with the predefined remaining service life time.

According to the invention, the first step is to determine the actual and technical, respectively, remaining service life time (respectively the remaining actual respectively technical usable life time) of a first wind turbine. The actual remaining service life time of the wind turbine may also be referred to as “Remaining Useful Life” (RUL). The determining is based on a provided model of at least one reference wind turbine. In other words, the model is based, in particular, on at least one reference wind turbine.

At least one first operating data set from this wind turbine, in particular, a plurality of first operating data sets, may be used as at least one input parameter of such a model for (directly or indirectly) determining the actual remaining service life time of a wind turbine.

The at least one first operating data set may, in particular, have been detected and recorded during the operating of the first wind turbine (prior to the time at which the actual remaining service life time of this wind turbine is determined).

In particular, the wind characteristics relevant to the service life time can be derived from an operating data set of an operational period and used to determine the remaining service life time of this wind turbine.

An operating data set contains at least one operating parameter value of a (e.g., first) wind turbine. Preferably, an operating data set contains a plurality of such operating parameters (values). An operating parameter refers, in particular, to an operating parameter of the wind turbine detected during the operating of the wind turbine (for the operation of the wind turbine) that relates to the operation of the wind turbine. Preferably, a provided operating data set of the (e.g., first) wind turbine is a SCADA operating data set of the (e.g., first) wind turbine respectively an operating data set of the (e.g., first) wind turbine containing at least one SCADA operating parameter of the (e.g., first) wind turbine.

In variants of the invention, preferably, in addition to the at least one first operating data set, at least one first load data set may be used as a further input parameter of the model. A load data set, in particular, in the form of a fatigue load data set, may contain at least one structural and/or mechanical load parameter respectively a load parameter value of a (previously described) structural component of a (e.g., first and/or reference) wind turbine.

A load data set can, in particular, be generated by an SHM system.

In particular, during the operation of a wind turbine, load parameter values of at least one load parameter of this wind turbine and operating parameter values of at least one operating parameter of this wind turbine can be simultaneously detected (and, in particular, recorded).

A plurality of time-dependent operating data sets can then be generated from the detected values of the at least one operating parameter, in particular, using conventional methods. In particular, each operating data set may be assigned an operating data time duration (e.g., a timestamp) that refers to the measurement period during which the at least one operating parameter was measured and detected, respectively. For example, an operating data time duration may comprise a start time (formed, in particular, by date and time (e.g., 1/1/21, 1:00 a.m.)), a duration (preferably between 5 and 30 minutes, in particular, (in a conventional manner) 10 minutes), and an end time (formed, in particular, by date and time (e.g., 1/1/21, 1:10 a.m.)).

A plurality of time-dependent load data sets can then be formed from the detected load parameter values of the at least one load parameter. In particular, to enable a (temporally) synchronized assignment of operating data sets to load data sets, the formation of load data sets may preferably be based on respectively correspond to the formation of the operating data sets (for example, as specified by a SCADA system in any case).

In particular, each load data set may be assigned a load data time duration (e.g., a timestamp) that refers to the measurement period of the measuring and recording, respectively, of the at least one load parameter. This load data time duration may be selected to correspond to the operating data time duration. For example, a load data time duration may comprise a start time (formed, in particular, by date and time (e.g., 1/1/21, 1:00 a.m.)), a duration (preferably between 5 and 30 minutes, in particular, (in a conventional manner) 10 minutes), and an end time (formed, in particular, by date and time (e.g., 1/1/21, 1:10 a.m.)).

By synchronously or synchronizedly assigning load data sets to operating data sets, in particular, depending on the respective assigned load data time duration respectively operating data time duration, input data sets can be formed for the model. In other words, a temporally synchronous respectively temporally synchronized assignment of temporally synchronous data sets, i.e., data sets with the same temporal dependency (e.g., the same timestamp), to one another can take place.

For example, an operating data set with a start time t_{A1} (e.g., Jan. 1, 2021, 1:00 a.m.), a duration T_{L1} (e.g., 10 min) and an end time t_{E1} (e.g., Jan. 1, 2021, 1:10 a.m.) is assigned to a load data set with a corresponding start time tai (e.g., Jan. 1, 2021, 1:00 a.m.), a corresponding duration T_{L1} (e.g., 10 min), and a corresponding end time t_{E1} (e.g., Jan. 1, 2021, 1:10 a.m.).

In particular, this synchronous assignment forms an input data set that (always) contains (exactly) one load data set (and the corresponding parameter values, respectively) and (exactly) one operating data set (and the corresponding parameter values, respectively), respectively is formed from these.

As will be described later, the model may preferably be a machine learning model (also referred to as a machine learning model respectively ML model). In variants of the invention, the model used to determine the actual remaining service life time may also be a different model.

The RUL can, for example (as an alternative to a machine learning model), be determined by the fatigue damage (cf. current plant condition) introduced into the structure of the wind turbine, i.e., the at least one structural component of the wind turbine, up to the evaluation time in comparison to the permissible damage (defined, for example, by the at least one plant condition limit value of the at least one structural component). It shall be understood that the permissible damage may include corresponding safety factors. In other words, the actual plant condition of the at least one structural component can be determined by comparison with a permissible plant condition, i.e., compared with at least one specific plant condition limit value.

The damage to a wind turbine can (as an alternative to the preferred machine learning model) be calculated by a computing device from the loads of the wind turbine respectively stresses of the wind turbine based on a suitable damage model for the wind turbine. In particular, a model can be used for each component respectively structural component under consideration. Thus, the continuous measurement of component loads on all wind turbines can be carried out over the entire service life time of the respective wind turbine, and the prediction can then be made using the damage model.

Furthermore, simulation models can be used (as an alternative to the preferred machine learning model) to determine, and in particular, estimate, the RUL of a wind turbine. For example, so-called aero-elastic simulation models can be used to estimate the loads of a component of a wind turbine. In particular, a simulation model represents a defined turbine type. The simulation models are then calibrated and validated using available operating data from a wind turbine, such as the power curve, thrust curve, foundation loads under design conditions, etc. The method may, in particular, comprise a calibrated aero-elastic simulation model that determines the actual remaining service life time using the operating data set.

One possibility for determining the remaining service life time of a wind turbine involves classifying the operating data sets from SCADA and SHM systems with respect to wind speeds and other operating parameters, grouping them into cohorts, and comparing them with the design characteristics to derive the remaining service life time.

After determining the actual remaining service life time of the first wind turbine, comparing is performed of this determined actual remaining service life time of the first wind turbine with a predefined remaining service life time of the first wind turbine. A wind turbine is designed, in particular, for a predefined respectively (fixed) specified service life time (e.g., between 15 and 30 years, for example 20 years). The predefined remaining service life time is derived from this predefined service life time and the time at which the actual remaining service life time of the first wind turbine is determined.

As has been previously described, a performance framework is also defined to ensure that the technical service life time actually corresponds to the predefined service life time (i.e., that no damage to the structural components occurs before the end of the predefined service life time). In the prior art, this is defined as fixed for the entire predefined service life time of the wind turbine. In particular, the performance framework for a wind turbine defines at least one maximum permissible performance parameter limit value that must not be exceeded during the operation of the wind turbine. In other words, the wind turbine is controlled respectively regulated in such a way as to prevent the at least one maximum permissible power parameter limit value from being exceeded. For example, at least the (permissible) rated power of a wind turbine may be defined in the corresponding performance framework. Furthermore, the performance framework may comprise a maximum permissible cut-off wind speed. The cut-off wind speed can be increased; that is, operating durations at higher cut-off wind speeds lead to accelerated aging, provided these wind speeds occur during the operational phase. At these wind speeds, production operation with reduced electrical power would also be conceivable.

According to the invention, it is provided that the performance framework is adjusted and modified, respectively, depending on the comparison result. Thus, according to the invention, a performance adjustment of the aforementioned predefined performance framework of the first wind turbine is carried out for a defined future period in such a way that an alignment of the actual remaining service life time of the first wind turbine and the predefined remaining service life time of the first wind turbine is achieved, (only) if a predefinable deviation is detected between the actual remaining service life time of the first wind turbine and the predefined remaining service life time of the first wind turbine.

For example, the adjusting may comprise changing at least one performance parameter, in particular, the at least one maximum permissible performance parameter limit value, of the performance framework, for example, by a predetermined value and/or depending on the magnitude of the deviation determined in the comparison between the actual remaining service life time and the predefined remaining service life time. For example, it may be provided that the higher the detected deviation is, the greater the adjusting respectively the adjustment value of the at least one performance parameter of the performance framework will be.

A performance adjustment is performed at least if a predefinable, in particular, predefined (minimum) deviation has been detected. In particular, this ensures that an adjustment is not always performed even in the case of minor deviations.

The performance adjustment is carried out for a future period. This means, in particular, that the change to the at least one performance parameter (limit value) remains in effect at least for the defined future period. Upon expiration of the future period, the adjustment can, for example, be automatically reset, i.e., in particular, the at least one adjusted performance parameter limit value can be reset to the originally predefined performance parameter limit value As will be described further, in a preferred embodiment, upon expiration of the future period, a renewedly determining of the actual remaining service life time present at that determination point in time as well as a subsequent comparing may be performed to (re-) evaluate whether a reset or a further adjustment of the performance framework should take place.

The future period may, for example, range from 1 month to 5 years, preferably from 6 months to 2 years, and may, for example, essentially amount to one (operating) year.

According to a further embodiment of the method of the invention, the first wind turbine may be operated based on the adjusted performance framework during the defined future period. In particular, a control device, such as the aforementioned computing device, may control and regulate, respectively, the first wind turbine such that the at least one permissible performance parameter limit value of the adjusted performance framework is maintained during the defined future period.

According to a preferred embodiment of the method of the invention, performing a performance adjustment of a predefined performance framework of the first wind turbine for a defined future period may comprise
increasing at least one permissible performance parameter limit value (by a preset value, for example X percent, e.g., between 0.1 and 10%) of the performance framework upon determining that the actual remaining service life time of the first wind turbine is greater than the predefined remaining service life time of the first wind turbine by a predefinable deviation.

By increasing the at least one permissible performance parameter limit value of the power framework, the energy yield can be increased in an in particular simple manner while simultaneously ensuring that the predefined remaining service life time is not exceeded. Preferably, the (maximum permissible) rated power can be increased (as at least one permissible performance parameter limit value), for example by between 0.1% and 10%, preferably between 1% and 5%, for example, by 2%. Alternatively, the cut-off wind speed can be slightly increased, e.g., from 25 m/s to 26 m/s, or instead of shutting down, continued operation at reduced power, e.g., 50% of the rated power, could be performed. Furthermore, the direction of the airflow relative to the rotor can be altered by changing the yaw angle such that the wake of a first wind turbine has a lesser influence on a second wind turbine that is at least partially in the wake.

According to a further embodiment of the method of the invention, performing a performance adjustment of a predefined performance framework of the first wind turbine for a defined future period may comprise:
reducing at least one permissible performance parameter limit value (by a preset value, for example X percent) of the performance framework upon determining that the actual remaining service life time of the first wind turbine is less than the predefined remaining service life time of the first wind turbine by a predefinable deviation.

By reducing at least one permissible performance parameter limit value of the performance framework, the consumption of the service life time can be reduced in a particularly simple manner, thereby ensuring that the predefined remaining service life time is not exceeded. Preferably, the (maximum permissible) rated power can be reduced (as at least one permissible performance parameter limit value), for example by between 0.1% and 10%, preferably between 1% and 5%, for example by 2%.

As has been previously described, the described method steps of determining the actual remaining service life time, comparing the determined actual remaining service life time, and performing the performance adjustment may preferably be carried out multiple times (during the predefined service life time of a wind turbine), for example on a regular basis (e.g., after the expiration of the defined future time period).

According to a preferred embodiment of the method of the invention, the method may comprise, at least upon an expiration of the defined future time period:
re-determining the actual remaining service life time of the first wind turbine, based on the model of the reference wind turbine and at least one second set of operating data for the first wind turbine detected during the defined future period,
comparing the re-determined actual remaining service life time of the first wind turbine with the predefined remaining service life time of the first wind turbine, and
performing a renewed performance adjustment of a predefined performance framework of the first wind turbine for a further defined future period such that the actual remaining service life time of the first wind turbine is aligned with the predefined remaining service life time of the first wind turbine upon a re-determining of a predefinable deviation between the re-determined actual remaining service life time of the first wind turbine and the predefined remaining service life time of the first wind turbine and/or upon a determining of a predefinable match between the re-determined actual remaining service life time of the first wind turbine and the predefined remaining service life time of the first wind turbine.

In particular, throughout the entire service life time of a wind turbine, it can be regularly determined whether a performance adjustment should be performed based on the respective comparison result. Depending on the comparison result, the at least one permissible performance parameter limit value of the power framework can be reset, remain unchanged, or be adjusted again, for example, increased or decreased again.

As has been previously described, the first wind turbine is, in particular, a wind turbine of a wind farm. A wind farm may, in particular, comprise a plurality of (first) wind turbines. Preferably, optimization of the energy yield may be performed not only with respect to one of these wind turbines, but (additionally) with respect to the entire wind farm.

According to a preferred embodiment of the method of the invention, the method may further comprise:
performing the method (or at least the aforementioned method steps of determining the actual remaining service life time, comparing the determined actual remaining service life time, and performing the performance adjustment) for a plurality of wind turbines (in particular, all wind turbines) of the wind farm, and
performing a respective performance adjustment of a predefined respective performance framework of the respective wind turbine (of the plurality of wind turbines) for the defined future period such that an alignment of the actual respective remaining service life time of the respective wind turbine with the respective remaining service life time of the respective wind turbine and an alignment of the respective remaining service live times with one another is effected upon determining of at least one predefinable deviation between the respective actual remaining service life time of the respective wind turbine and the respective predefined remaining service life time of the respective wind turbine.

In other words, an adjustment may be made, in particular, such that preferably all wind turbines each have an actual service life time that is essentially identical to one another. This ensures that, as far as possible, all wind turbines in a wind farm reach the end of their service life time essentially at the same time. In particular, with regard to an offshore wind farm, it has been recognized that continuing to operate only a portion of the wind turbines is disadvantageous for cost reasons. By now performing performance optimization with respect to the entire wind farm in addition to individual performance optimization, the energy yield of the entire wind farm can be further increased.

According to a further preferred embodiment of the method of the invention, the method may further comprise:
extending the predefined remaining service life time of the first wind turbine upon determining that the actual remaining service life time of the first wind turbine is greater than the predefined remaining service life time of the first wind turbine by a predefinable deviation.

In particular, the predefined remaining service life time of a wind turbine may be adjusted to the actual remaining service life time. For example, the predefined remaining service life time may be increased or reduced accordingly. This may be particularly preferred when the respective actual remaining service life time of at least nearly all wind turbines in a wind farm is essentially the same. In that case, the predefined remaining service life time of the wind farm can be adjusted to the actual remaining service life time of the wind farm (which may essentially correspond to the nearly identical actual remaining service live times of the respective wind turbines), in particular, by extending it accordingly.

This independently inventive aspect may, in particular, be performed without the step of performing a performance adjustment of a predefined performance framework of the first wind turbine for a defined future period such that an alignment of the actual remaining service life time of the first wind turbine and the predefined remaining service life time of the first wind turbine is effected upon determining of a predefinable deviation between the actual remaining service life time of the first wind turbine and the predefined remaining service life time of the first wind turbine.

In variants of the invention, the method may further comprise:
reducing the predefined remaining service life time of the first wind turbine upon determining that the actual remaining service life time of the first wind turbine is less than the predefined remaining service life time of the first wind turbine by a predefinable deviation.

According to a particularly preferred embodiment of the method of the invention, determining the actual remaining service life time of a first wind turbine may comprise using a machine learning model of the reference wind turbine. A training of the machine learning model of the reference wind turbine may comprise:
providing a plurality of operating data sets of the reference wind turbine,
providing a plurality of load data sets for the reference wind turbine, wherein a load data set is based on at least one load parameter measured at the reference wind turbine, and generating a plurality of wind power training data sets for training a machine learning model by synchronously assigning a respective operating data set with a respective load data set.
providing damage statistics for identical wind turbines from other wind farms
providing damage statistics for identical wind turbines in the wind farm).

In particular, the method may comprise a method for training a machine learning model. In other words, a machine learning model can be trained. The trained machine learning model is subsequently usable, in particular indirectly, for determining the remaining service life time of a wind turbine.

The machine learning model (also referred to as a machine learning model) may preferably be an artificial neural network and/or comprise one.

An artificial neural network comprises artificial neurons. Such a neuron is, in particular, configured to receive at least one input from at least two other artificial neurons. The at least two inputs can each be received by means of at least one connection with a specific (trainable) weight.

An artificial neuron may further be configured to integrate the at least one input into at least one output, for example, by summing at least two received inputs and applying a function, such as a sigmoid transformation, to the sum to generate an output. The output of an artificial neuron, in particular, multiplied by a connection weight of a further connection to a further neuron, can form an input for that further neuron.

In particular, for the at least one reference wind turbine, a plurality of operating data sets of this at least one reference wind turbine and a plurality of (mechanical and/or structural) load data sets of this at least one reference wind turbine are provided.

As has been previously described, a current plant condition of a structural component can be determined, in particular, estimated, from load parameters respectively the load parameter values measured at a wind turbine during a measurement period.

It has been recognized that fundamentally there is a correlation between the load parameter values and the operating data values. In particular, it has been recognized that, using specialized training data sets containing both load parameter values and operating data values of a (reference) wind turbine, a machine learning model can be trained in such a way that this correlation respectively these correlations can be detected and represented within the machine learning model. In particular, a machine learning model can identify patterns between load parameter values and operating data values. These can be represented in the machine learning model.

This subsequently makes it possible to determine, and in particular, to estimate, the actual remaining service life time of a first (and each subsequent) wind turbine (at least indirectly) using (exclusively) the operating data of this first (or each subsequent) wind turbine. Thus, at least one set of operating data, preferably a plurality of sets of operating data, from a first wind turbine can be input into the machine learning model, i.e., provided as input(s). As an output, the machine learning model can provide at least one plant condition data set, which may already contain an (estimated) remaining service life time or at least one plant condition indicator (e.g., at least one fatigue load indicator) from which the remaining service life time can be determined, in particular, estimated in a conventional manner.

In order to form a plurality of training data sets, a plurality of operating data sets and a plurality of load data sets from a reference wind turbine may be provided.

A reference wind turbine refers, in particular, to a wind turbine in operation, in particular, within the wind farm that also comprises the first wind turbine, and whose operating parameter values and load parameter values are detected to form training data sets. A reference wind turbine may be selected in any manner from a plurality of (first) wind turbines in a wind farm.

An operating data set of the reference wind turbine may contain at least one operating parameter value of the reference wind turbine. Preferably, an operating data set contains a plurality of such operating parameters (values). As has been described, an operating parameter refers, in particular, to an operating parameter of the wind turbine detected during the operation of a wind turbine (for the operation of the wind turbine) which relates to the operation of the wind turbine. Preferably, a provided operating data set of the reference wind turbine is a SCADA respectively SHM operating data set of the reference wind turbine, or an operating data set of the reference wind turbine containing at least one SCADA respectively SHM operating parameter of the reference wind turbine.

A load data set of the reference wind turbine, in particular, in the form of a fatigue load data set, may contain at least one structural and/or mechanical load parameter respectively load parameter value of a (previously described) structural component of the reference wind turbine.

In particular, during the operation of a reference wind turbine, load parameter values of at least one load parameter of the reference wind turbine and operating parameter values of at least one operating parameter of the reference wind turbine can be detected simultaneously.

From the detected operating parameter values of the at least one operating parameter, a plurality of time-dependent operating data sets can then be formed, in particular, in the manner described above.

From the detected load parameter values of the at least one load parameter, a plurality of time-dependent load data sets can then be formed, in particular, in the manner described above. In particular, to enable a (temporally) synchronized assigning of operating data sets to load data sets, the formation of load data sets may preferably be oriented toward or correspond to the formation of the operating data sets (for example, as dictated by a SCADA system in any case).

In order to generate wind power training data sets, a synchronous respectively synchronized assigning of load data sets to operating data sets may take place, in particular, depending on the respective assigned load data time duration and operating data time duration, respectively. In other words, a temporally synchronous respectively temporally synchronized assignment of temporally synchronous data records, i.e., data sets with the same temporal dependency (e.g., the same timestamp), to one another can be performed.

By means of the synchronous assigning, a wind power training data set can be formed that (always) contains (exactly) one load data set (respectively the corresponding parameter values) and (exactly) one operating data set (respectively the corresponding parameter values), respectively is formed therefrom.

According to an embodiment of the method of the invention, the machine learning model can be trained (in a conventional manner) with the generated wind power training data sets during a training period. In other words, the generated wind power training data sets are provided to the machine learning model, in particular, for the purpose of training.

According to a further embodiment of the method of the invention, a portion (for example, between 10% and 30%, preferably between 15% and 25%) of the generated wind power training data sets may be used as validation data sets during a training period. In particular, the training performance of a machine learning model can be assessed using validation data sets, i.e., validated. The validation data sets can preferably be selected randomly from the generated wind power training data sets.

According to a preferred embodiment of the method of the invention, a provided operating data set may contain at least one operating parameter (respectively a detected operating parameter value) of a (e.g., first or reference) wind turbine. The at least one operating parameter may be selected from the group, comprising:
tower top acceleration,
pitch angle (also referred to as pitch angle),
pitch speed (in particular, the speed at which the blade is adjusted)
rotor speed (also known as rotor speed),
electrical power, in particular active power (also known as active power),
nacelle wind speed(s) (also referred to as nacelle wind speed(s)).

Additional operating data comprises, for example, wind speed frequency and turbulence intensity, power production, temperatures, vibrations, and electrical currents. Alternatively or additionally, operating data may comprise SHM (Structural Health Monitoring) data, such as structural stresses, natural frequencies, and, in particular, changes in crack propagation velocity in components, e.g., based on observed crack propagation in past years of operation or simulated damage patterns, statistics and repairs of components relevant to service life time, e.g., complex failures in rotor blade laminates that cannot be assessed through computational verification, occurrence, frequency, and duration of operational events such as emergency shutdowns, cold starts, structural resonance effects (e.g., vortex-induced vibrations), grid losses, curtailment by grid operators, wind farm operators, or power plant controllers.

The operating data set may comprise only one of the aforementioned operating parameters, preferably two of the aforementioned operating parameters, and most preferably all of these operating parameters. It shall be understood that, if necessary, additional operating parameters not explicitly mentioned here may also be provided as an alternative or in addition. In particular, at least one sensor module, in particular, a plurality of (different) sensor modules, may be provided to measure the at least one operating parameter respectively its operating parameter values (preferably continuously). The measured operating parameter values and/or signals of an operating parameter can then be made available to the SCADA system, for example, by means of a measurement amplifier.

Preferably, an operating data set comprises an operating data time duration, as has been described above.

According to a further embodiment of the method of the invention, an operating data set of a (e.g., first or reference) wind turbine may comprise, as an operating parameter value of an operating parameter, at least one operating parameter value selected from the group comprising:
the maximum operating parameter value detected during (the duration of) the operating data time duration of the operating data set,
the minimum operating parameter value detected during (the duration of) the operating data period of the operating data set,
average operating parameter value determined from the operating parameter values detected during (the duration) of the operating data period of the operating data set,
standard deviation determined from the operating parameter values detected during (the duration of) the operating data period of the operating data set.

An operating data set may comprise two of the aforementioned operating parameter values for the at least one operating parameter, preferably all of these operating parameter values. This allows for the creating of higher-quality training data sets.

A preferred example of an operating data set for a (e.g., first or reference) wind turbine is provided in Table 1.

TABLE 1

| Operating parameter | Operating parameter value |
|---|---|
| Tower top acceleration | Max. acceleration value |
| | Min. acceleration value |
| | Average acceleration value |
| | Standard deviation of acceleration values |
| Pitch angle | Maximum angle value |
| | Minimum angle value |
| | Average angle value |
| | Standard deviation of the angle values |
| Rotor speed | Max. speed value |
| | Minimum speed value |
| | Average speed value |
| | Standard deviation of the speed values |
| Electrical power, | Maximum power value |
| in particular, | Minimum power value |
| active power | Average power value |
| | Standard deviation of power values |
| Gondola wind speed | Maximum speed value |
| | Minimum speed value |
| | Average speed value |
| | Standard deviation of speed values |
| Oblique wind flow | Maximum oblique flow |
| | Minimum oblique flow |
| | Average oblique flow |
| | Standard deviation of the oblique flow values |

The preferred operating parameters described above refer, in particular, to onshore wind turbines.

It has been recognized that, for an offshore wind turbine, an operating data set should comprise at least one additional (offshore-related) operating parameter respectively an additional operating data set with at least one additional (offshore-related) operating parameter should be provided. In particular, it has been recognized that, for an offshore wind turbine, an operating data set (respectively an additional offshore operating data set that can be assigned in accordance with the described synchronous mapping) may contain at least one water condition parameter. A water condition parameter refers, in particular, to a parameter that indicates the condition of the water (in particular, the sea) surrounding the offshore wind turbine.

The at least one water condition parameter is preferably a hydrodynamic parameter. The at least one water condition parameter may be a wave parameter (e.g., wave height, wave direction, and/or wave frequency) and/or a current parameter (e.g., current velocity and/or current direction).

An example of an (offshore) operating data set for a (e.g., first or reference) wind turbine with offshore-related operating parameters is provided in Table 2.

TABLE 2

| Operating parameter | Operating parameter value |
|---|---|
| Wave height | Max. height value |
| | Min. height value |
| | Average height value |
| | Standard deviation of height values |
| Wave frequency | Maximum frequency value |
| | Minimum frequency value |
| | Average frequency value |
| | Standard deviation of the frequency value |
| Flow velocity and/or | Maximum velocity value |
| wave velocity | Minimum velocity value |
| | Average velocity value |
| | Standard deviation of the velocity values |
| Directional deviation | Maximum directional deviation |
| of wind relative to | Minimum direction deviation |
| waves | Average directional deviation |
| | Standard deviation of direction deviation values |

It shall be understood that Table 1 and Table 2 can be combined with one another.

According to a further preferred embodiment of the method of the invention, preprocessing of the provided operating parameter values and/or load parameter values and/or wind power training data parameter values may be performed. In particular, the quality of the training data sets can be improved if the quality of the aforementioned values is improved (e.g., erroneous values due to measurement errors are identified in advance and then, in particular, ignored or replaced with more appropriate values using suitable means).

Preprocessing may, in particular, comprise at least one of the following measures:
removing invalid operating parameter values and/or load parameter values and/or wind power training data parameter values (respectively corresponding outliers). This is preferably done by means of direct indicators of the wind plant condition (wind plant condition signal in SCADA and/or SHM, if available) and/or indirectly by means of the power signal in SCADA in conjunction with the power curve specification.
extracting a suitable set of features/parameter values by taking into account the collinearity of the features/parameter values. This can be done by calculating the correlations between the parameters and comparing them with an acceptable upper limit.
alternatively, all features/parameter values (with the exception of those that are highly collinear) can be retained, and a machine learning method with implicit feature selection can be used (e.g., Bayesian LASSO (see, e.g., Trevor Park & George Casella (2008), The Bayesian Lasso, Journal of the American Statistical Association) or MARS). This can be done, for example, using a regression technique such as multivariate regression (see, e.g., Friedman, J. H. (1991), “Multivariate Adaptive Regression Splines”).
scaling of the operating parameter values and/or load parameter values and/or wind power training data parameter values, e.g., standardization of the operating parameter values with a zero mean and, for example, constant variance (usually equal to 1).

Other transformations are also conceivable. In particular, the goal is always that the variables are approximately standard normally distributed after the transformation.

According to a further preferred embodiment of the method of the invention, a provided load data set may be based on at least one measured load parameter of the reference wind turbine. “Based on” means, in particular, that the load data set does not directly comprise the (measured) load parameter values of the at least one load parameter, but rather fatigue load indicators respectively indicator values derived respectively determined therefrom.

The at least one load parameter of a (e.g., first or reference) wind turbine may preferably be selected from the group comprising:
blade root load parameter (also referred to as blade root load),
rotor load parameter (also referred to as rotor load),
tower load parameter (also known as tower load),
tower torsion parameter (also referred to as tower torsion),
tower top moment parameter (also referred to as tower top moment).

The load data set may be based on only one of the aforementioned load parameters. The load data set may be based on two of the aforementioned load parameters, preferably on all of these load parameters.

The at least one blade root load parameter may, in particular, be a blade bending parameter (also referred to as flap bending) and/or an edge bending parameter (also referred to as edge bending). Furthermore, the at least one rotor load parameter may be a tilt moment parameter (also referred to as tilt moment), a yaw moment (also referred to as yaw moment), and/or a rotor torque (also referred to as rotor torque). The at least one tower load parameter may be a tower base bending parameter (in two directions). The at least one tower top moment parameter may be a tilt moment parameter (also referred to as tilt moment), a yaw moment (also referred to as yaw moment), and/or a roll moment parameter (also referred to as roll moment).

From the aforementioned load parameters, a plant condition respectively a component condition of a defined component, in particular, a structural component, of a (e.g., first or reference) wind turbine can be determined.

The load parameter values of a load parameter can be measured (continuously) by at least one load sensor of a sensor arrangement and, in particular, made available. In particular, a measuring by the at least one load sensor can be performed at a high resolution (e.g., 20 Hz). A temporary storage of the measured values for further processing is possible. For this purpose, the at least one load sensor can be arranged at a suitable position in or at the wind turbine.

According to a particularly preferred embodiment of the method of the invention, the method may further comprise:
measuring the at least one load parameter of the reference wind turbine (and/or a first wind turbine),
wherein the measuring of the at least one load parameter is performed, in particular, in accordance with the standard IEC 61400-13 [2].

In particular, at least the (key) load parameters specified in Section 3.3.2 of the IEC 61400-13 standard [2] may be measured, in particular, in accordance with said standard.

According to a further embodiment of the method of the invention, a load parameter value may be provided as the load parameter value of a load parameter, which is selected from the group, comprising:
maximum load parameter value measured during (the duration of) the load data period,
minimum load parameter value measured during (the duration of) the load data period,
load parameter mean value determined from the load parameter values measured during (the duration of) the load data period,
standard deviation determined from the load parameter values measured during (the duration of) the load data period.

A load data set for a (e.g., first or reference) wind turbine may be based on at least two of the aforementioned load parameter values, preferably on all of these load parameter values. This allows a forming of higher-quality training data sets.

A preferred example of load parameters and load parameter values on which a load data set can be based is provided, in particular, in Table 3.

TABLE 3

| Load parameter | Load parameter value |
|---|---|
| Blade bending | Max. bending value |
| parameter | Min. bending value |
| | Average bending value |
| | Standard deviation of the bending values |
| Edge bending | Max. bending value |
| parameter | Minimum bending value |
| | Average bending value |
| | Standard deviation of the bending values |
| Rotor tilting | Max. moment value |
| moment | Minimum moment value |
| parameter | Average moment value |
| | Standard deviation of the moment values |

According to a further embodiment of the method of the invention, the method may further comprise:
a. measuring the at least one load parameter of the reference wind turbine during a measurement period, and
b. detecting the operating data of the reference wind turbine during the measurement period,
c. wherein the measurement period is, in particular, at least 3 months, preferably at least 6 months (and, for example, at most 36 months).

A timestamp of the measurement time may be assigned to each measured (digital) load parameter value. This may be taken into account (at least indirectly) to form a load data set and, in particular, for the synchronized assigning which has been described above.

During a measurement period, the at least one operating parameter can be continuously detected and, in particular, measured. For example, the measured data can be temporarily stored.

As has been previously described, corresponding data sets can be formed and then made available, in particular, to generate a plurality of wind power training data sets for training a machine learning model. In order to obtain a sufficient number of training data sets (in particular, assuming a duration of 10 minutes for each operating data set (and load data set)), the measurement period may be at least 3 months, preferably at least 6 months.

For example, approximately 100,000 wind power training data sets can be generated. Preferably, approximately 20,000 of these wind power training data sets can be used as validation data sets.

According to a further embodiment of the method of the invention, the method may further comprise:
d. forming a (time-dependent) load data set by converting the at least one measured load parameter value of the reference wind turbine into at least one fatigue load indicator,
e. wherein the converting is based, in particular, on an RFC method (Rainflow Counting) (also known as the Rainflow counting method) and
f. an LDD method (Load Duration Distribution) is used (also known as the load duration counting method).

As has been previously described, a load data set may be based on at least one measured load parameter value of at least one load parameter of the reference wind turbine. In particular, a load data set may be based on at least one converted load parameter value, i.e., in particular, may contain the at least one fatigue load indicator.

It is particularly preferred that the converting of the at least one measured load parameter value of the reference wind turbine into at least one fatigue load indicator can be performed in accordance with the ASTM E1049-85(2017) standard.

In order to obtain a high-quality machine learning model, so-called overfitting should be avoided during the training process. This means, in particular, that during the training process, it is ensured that the machine learning model recognizes only those patterns in the training data that are actually present and have not occurred randomly (once).

Therefore, according to a further preferred embodiment of the method of the invention, the invention proposes that at least one regularization technique be applied during the training period. This can at least reduce the risk of overfitting.

The at least one regularization technique may, in particular, be selected from the group comprising:
g. linear Bayesian regression (also referred to as Bayesian linear regression),
h. Bayesian neural network with concrete dropout (also referred to as Bayesian neural network by concrete dropout) or Bayesian by variational inference,
i. adaptive Bayesian spline regression (also known as Bayesian adaptive spline regression).

Such regularization techniques have proven to be particularly advantageous.

According to a further embodiment of the method of the invention, a model for estimating the aleatory and/or epistemic uncertainties may be used during the training period.

Furthermore, during the training process, a so-called loss function (also referred to as a loss function) may be used, for example, to evaluate the machine learning model at least in part based on the output. A loss function may, for example, include a metric for comparing the output with a reference value. A loss function may, for example, be defined when a reference output for a given input is known. For example, the loss function may be a so-called “Gaussian negative log likelihood function.”

In a training step of the training process, the machine learning model can be adjusted. Adjustment may, in particular, involve changing at least one parameter of the machine learning model.

A wind power training data set may preferably be in the form of text data, from which a suitable representation can be generated. The generated representation may, for example, be formed by a vector, a matrix, and/or a tensor.

As previously described, the trained machine learning model can be used to determine the plant condition of a first wind turbine, in particular, to estimate it, with a high degree of accuracy.

A machine learning model can, for example, be any algorithm that receives an input (in this case, in particular, at least one operating data set, preferably a plurality of historical and stored operating data sets from a (e.g., first) wind turbine) and returns an output (in this case, in particular, at least one turbine status data set, preferably containing at least one fatigue load indicator of at least one component of the (e.g., first) wind turbine), wherein the output depends on both the input and at least one parameter of the machine learning model.

As described, the machine learning model is trained beforehand to learn a relationship between inputs and outputs. The trained machine learning model can then be used to generate a new output from a new input.

In the present context, the inputs for the trained machine learning model are, in particular, operating data sets that can preferably be transformed into a vector, a matrix, and/or a tensor for input.

According to the invention, the trained machine learning model can be used for each wind turbine in a wind farm to determine the remaining service life time from the respective operating data set.

According to a further embodiment of the method of the invention, the first wind turbine may be a wind turbine type that is identical to the wind turbine type of the reference wind turbine. In other words, if the reference wind turbine is of type V1, then the trained machine learning model can preferably be used to determine, and in particular, to estimate, the plant condition and, in particular, the RUL of first wind turbines of the same or at least a similar type (i.e., type V.x). It shall be understood that the machine learning model trained according to the invention can still provide acceptable results even for similar types (for example, with a different hub height or foundation structure).

Alternatively or additionally, the first wind turbine and the reference wind turbine may be part of the same wind farm. In other words, the wind farm comprises a plurality of first wind turbines and at least one additional wind turbine, which serves, in particular, as a reference wind turbine.

In order to determine the turbine respectively plant condition respectively state and, in particular, the RUL of preferably all wind turbines in a wind farm, at least one wind turbine of the wind farm (in variants of the invention, more than one, for example two, may be selected) may be selected as the reference wind turbine. After training a machine learning model as described above, the plant condition and, in particular, the RUL of at least one first wind turbine, preferably all first wind turbines, of the wind farm can be determined using the trained machine learning model.

According to a preferred embodiment of the method of the invention, the method may further comprise:
j. determining the actual remaining service life time of the first wind turbine based on the at least one plant condition data set of the first wind turbine.

As previously described, the actual remaining service life time (RUL (Remaining Useful Life)) of the at least one first wind turbine can be estimated with high accuracy from the output plant condition data set (in particular, using known estimation methods).

For some components and structural elements, respectively, of a wind turbine, such as steel tubular towers, the damage (and thus the RUL) can be estimated using structural models of the tower shell and the welds (and the plant condition data set). For this purpose, welding details, tower geometry (e.g., thicknesses, diameters), and material properties may be known or (conservatively) estimated.

For structural components, such as rotor blades, machine frames, generator supports, and/or hubs, however, this would entail a considerable effort to determine material quality and geometries, create FEM models, and calculate fatigue strength. Such an approach is only reasonable if more detailed information can be obtained from the turbine manufacturer or if the number of turbines of the type under consideration is large enough.

A variant of the other option could involve selecting wind conditions from the measurements that are close to the design conditions of a turbine, taking the reference loads from the measurements themselves, and extrapolating them to the predefined service life time (e.g., 20 years).

According to an embodiment of the computing device comprising at least one data storage containing computer program code, and at least one processor, the program code and the processor may be configured such that the computing device is caused to generate at least one plant condition data set based on at least one provided operating data set and at least partially using a machine learning model that has been trained as has, in particular, been described.

The machine learning model may, in particular, be stored in the data storage.

A further aspect of the invention is a wind farm, in particular, an offshore wind farm, comprising at least one computing device according to one of the preceding claims, and at least one first wind turbine (and preferably at least one reference wind turbine). It shall be understood that a wind farm may comprise further structures, such as a substation, a measuring station, etc.

A previously described module, element, etc., may comprise at least partially hardware elements (e.g., processor, memory means, etc.) and/or at least partially software elements (e.g., executable code).

The features of the methods and computing devices may be freely combined with one another. In particular, features of the description and/or the dependent claims may be independently inventive, either on their own or in free combination with one another, even if they completely or partially bypass features of the independent claims.

### BRIEF DESCRIPTION OF THE DRAWINGS

There are now a multitude of possibilities for configuring and further developing the method and computing device of the invention. In this regard, reference is made, on the one hand, to the patent claims subordinate to the independent patent claims and, on the other hand, to the description of embodiments in conjunction with the drawing. The drawing shows:

FIG. 1 shows a schematic view of an embodiment of a wind farm according to the present invention with a plurality of wind turbines,

FIG. 2 shows a diagram of an embodiment of a method according to the present invention,

FIG. 3a shows a diagram of a further embodiment of a method according to the present invention,

FIG. 3b shows a diagram of a further embodiment of a method according to the present invention,

FIG. 4 shows a diagram of a further embodiment of a method according to the present invention,

FIG. 5 shows an exemplary plant condition diagram,

FIG. 6 shows an exemplary diagram for testing collinearity by correlation, and

FIG. 7 shows a schematic view of an embodiment of a computing device according to the present invention.

### DETAILED DESCRIPTION

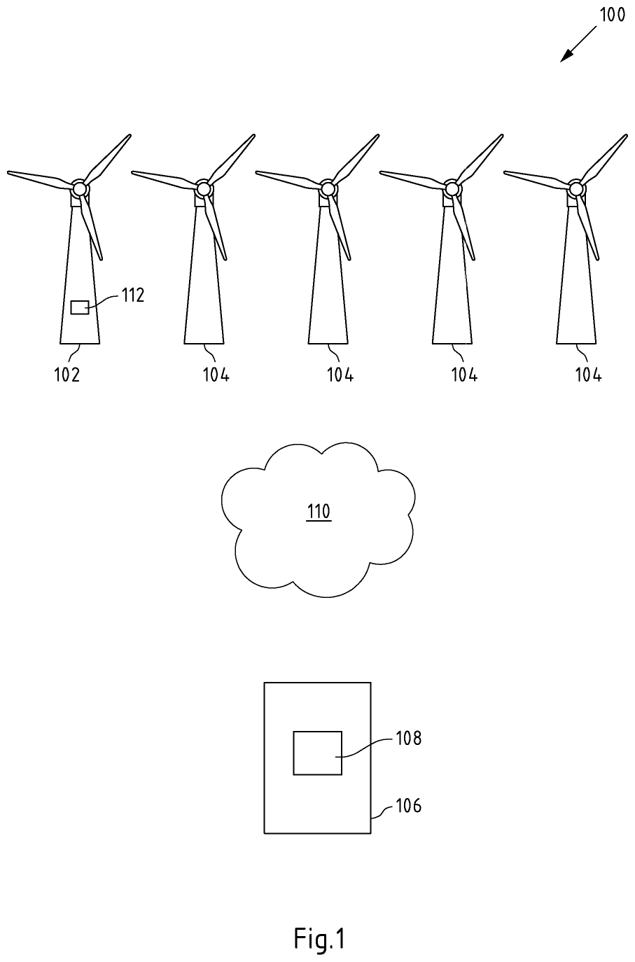

FIG. 1 shows a schematic view of a preferred embodiment of a wind farm 100 according to the present invention comprising a plurality of wind turbines 102, 104. Here, reference numeral 102 denotes the (selected) reference wind turbine and reference numeral 104 denotes the first wind turbines of the wind farm 100. The wind farm 100 may be an onshore wind farm and/or an offshore wind farm.

The wind farm 100 may preferably comprise a (central) control device 106 (e.g., formed by the aforementioned computing device), in particular, comprising at least one control module 108, for example a SCADA control module 108. The control device 106 with the control module 108 may be configured to control the wind farm, in particular, the wind turbines 102, 104 based on the respective predefined performance frameworks.

Furthermore, the operating parameter values of at least one operating parameter of at least one wind turbine 102, 104, preferably all wind turbines 102, 104, of the wind farm 100 can be detected and transmitted, for example, via a (wireless and/or wired) communication network 110 to the (central) control device 106. Preferred operating parameters are, for example, the parameters listed in Table 1.

As previously described, the at least one control module 108 can preferably control and/or regulate the wind farm 100 in a conventional manner based at least on the respective predefined performance frameworks of the respective wind turbines 102, 104.

Furthermore, the operating data sets can be recorded and stored, respectively, (in a data storage not shown, (e.g., of the control device 106)). This may in any case be provided for documentation purposes. Preferably, the operating data sets of the wind turbines 102, 104 can be stored and used to determine a respective plant condition of the respective wind turbine 102, 104, in particular, to determine the respective actual remaining service life time of the respective first wind turbines 104 (as will be described below).

As can further be seen, at least the reference wind turbine 102 comprises a sensor arrangement 112 with at least one load sensor (in particular, a plurality of load sensors). The at least one load sensor is configured to measure at least one load parameter (e.g., blade root load parameter, rotor load parameter, tower load parameter, tower torsion parameter, and/or tower top moment parameter).

The measured load parameter values of the at least one load parameter can preferably be stored in a (not shown) data memory (e.g., of the control device 106) for subsequent further processing, as will be described below.

Preferably, the wind turbines 102, 104 of the wind farm 100 may be of the same wind turbine type.

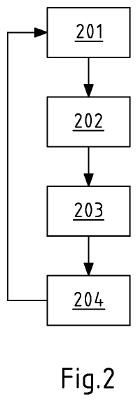

FIG. 2 shows a diagram of an embodiment of a method according to the present invention. The method may be executed, in particular, by a computing device, which may, in particular, be formed by the control device shown in FIG. 1. In particular, the method may be used in a wind farm, for example, as shown in FIG. 1. The computing device comprises at least one data storage containing computer program code and at least one processor, wherein the data storage and the processor are configured such that the computing device is caused to execute the method shown in FIG. 2.

In step 201, a determining is performed of the actual remaining service life time of a first wind turbine in the wind farm based on a model of at least one reference wind turbine (of the wind farm) and on at least one first operating data set for the first wind turbine, preferably a plurality of sets of operating data (as has been described).

In step 202, a comparing is performed of the determined actual remaining service life time of the first wind turbine with a predefined remaining service life time of the first wind turbine (as has been described).

In step 203, a performance adjustment of a predefined performance framework of the first wind turbine is performed for a defined future period such that an alignment of the actual remaining service life time of the first wind turbine is effected with the predefined remaining service life time of the first wind turbine upon determining a predefinable deviation between the actual remaining service life time of the first wind turbine and the predefined remaining service life time of the first wind turbine (as has been described). Performing a performance adjustment of a predefined performance framework of the first wind turbine for a defined future period may comprise increasing at least one permissible performance parameter limit value (by a preset value, for example X percent) upon determining that the actual remaining service life time of the first wind turbine is greater than the predefined remaining service life time of the first wind turbine by a predefinable deviation. Preferably, the rated power can be increased, for example, by between 1 and 5%.

Subsequently, in step 204, the control device may control the first wind turbine in accordance with the adjusted performance framework at least during the defined future period.

At least upon an expiration of the defined future period, the method may continue with step 201. In particular, the following may occur: Redetermining (step 201) the actual remaining service life time of the first wind turbine based on the model of the reference wind turbine and at least one second set of operating data for the first wind turbine detected during the defined future period, a (re) comparing (step 202) the re-determined actual remaining service life time of the first wind turbine with the predefined remaining service life time of the first wind turbine, and (re) performing (step 203) a re-adjustment of a predefined performance framework of the first wind turbine for a further defined future period such that an alignment of the actual remaining service life time of the first wind turbine is effected with the predefined remaining service life time of the first wind turbine upon a renewed determining of a predefinable deviation between the re-determined actual remaining service life time of the first wind turbine and the predefined remaining service life time of the first wind turbine and/or upon a determination of a predefinable match between the re-determined actual remaining service life time of the first wind turbine and the predefined remaining service life time of the first wind turbine.

The method may further comprise performing the method for a plurality of wind turbines in the wind farm. In this context, a respective performance adjustment of a predefined respective performance framework of the respective wind turbine may be performed (step 203) for a defined future period such that an alignment of the actual respective remaining service life time of the respective wind turbine with the respective remaining service life time of the respective wind turbine and an alignment of the respective remaining service live times with one another is effected upon determining at least one predefinable deviation between the respective actual remaining service life time of the respective wind turbine and the respective predefined remaining service life time of the respective wind turbine.

Furthermore, in step 203, the predefined remaining service life time of the first wind turbine may be extended if it is determined that the actual remaining service life time of the first wind turbine is greater than the predefined remaining service life time of the first wind turbine by a predefinable deviation.

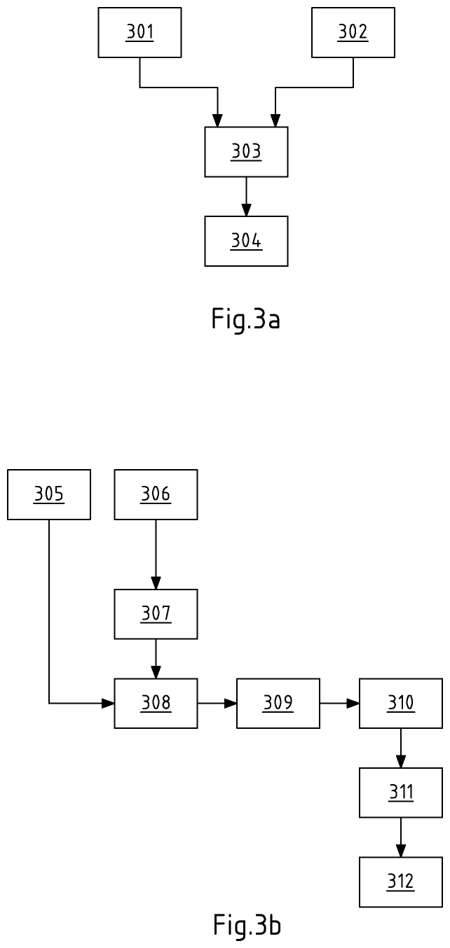

FIG. 3a shows a diagram illustrating an embodiment of a method according to the present invention. The method is, in particular, a computer-implemented method for training a machine learning model. The machine learning model is suitable for indirectly determining the remaining service life time of a wind turbine, in particular, for determining the structural and/or mechanical condition of the wind turbine, in particular, in step 201 of FIG. 1.

In step 301, a providing of plurality of operating data sets from a reference wind turbine may be performed. An operating data set is, in particular, a SCADA operating data set. For an onshore wind turbine, the operating data set may be formed in accordance with the exemplary Table 1. It shall be understood that other, additional, or fewer operating parameters and/or values may be included. For an offshore wind turbine, the operating data set may be formed in accordance with the exemplary Tables 1 and 2. This includes, in particular, that an operating data set may be formed from two separate sub-operating data sets. It shall be also understood here that other, additional, or fewer operating parameters and/or values may be included

In particular, each operating data set may be assigned an operating data time duration that refers to the measurement period of the at least one operating parameter. For example, an operating data time duration may comprise a start time (e.g., January 1, 2021, 1:00 a.m.), a duration (e.g., 10 min), and an end time (e.g., January 1, 2021, 1:10 a.m.).

In particular, the plurality of operating data sets may be provided for the entire detecting duration and measurement duration, respectively.

In step 302, a providing of a plurality of load data sets of the reference wind turbine may be performed, wherein a load data set is based on at least one load parameter measured on the reference wind turbine.

In particular, each load data set may be associated with a load data time period that relates to the measurement period of the at least one load parameter. This load data time period may be selected to correspond to the operating data time period.

For example, a load data time duration may comprise a start time (e.g., January 1, 2021, 1:00 a.m.), a duration (e.g., 10 min), and an end time (e.g., January 1, 2021, 1:10 a.m.). In other embodiments of the invention (in particular, when the duration is always fixed), an operating data time duration and/or a load data time duration may also be sufficiently defined by a single timestamp.

In a further step 303, a generating of a plurality of wind power training data sets may be performed for training a machine learning model. The generating is performed by synchronously assigning a respective operating data set to a respective load data set.

The (temporally) synchronized assignment of an operating data set to a load data set is performed in particular depending on the respective assigned load data time durations or operating data time durations. In particular, the start time and/or the end time can be evaluated for this purpose. For example, if, as in the example mentioned above, the start time (e.g., Jan. 1, 2021, 1:00 a.m.) and/or end time (e.g., Jan. 1, 2021, 1:10 a.m.) of an operating data set and a load data set are the same, then these operating data sets can be assigned to one another.

This assigning involves, in particular, creating a wind power training data set containing the data from the operating data set and the assigned load data set. In other words, an operating data set can be correlated with a load data set to form a wind power training data set.

Exemplary wind power training data sets WTD₁, WTD₂, . . . , WTDₙ (where n is a natural number representing different training data set time durations to correspondingly represent different operating data time durations) are shown in Table 4. The parameter values listed are illustrative examples.

TABLE 4

| | WTD₁ | WTD₂ | WTDₙ |
|---|---|---|---|
| Blade_Load_Ind | 4.002E+03 | 4.344E+03 | 4.172E+03 |
| Blade_Load_dev_Ind | 2.444E+02 | 3.050E+02 | 1.811E+02 |
| Power_Active_Mean | 1.300E+03 | 1.465E+03 | 1.370E+03 |
| Power_Active_Min | 1.067E+03 | 1.175E+03 | 1.195E+03 |
| Power_Active_Max | 1.502E+03 | 1.757E+03 | 1.568E+03 |
| Power_Active_dev | 1.081E+02 | 1.707E+02 | 6.498E+01 |
| Rotor_Speed_Mean | 1.179E+01 | 1.223E+01 | 1.205E+01 |
| Rotor_Speed_Min | 1.117E+01 | 1.170E+01 | 1.153E+01 |
| Rotor_Speed_Max | 1.224E+01 | 1.258E+01 | 1.240E+01 |
| Rotor_Speed_dev | 3.198E−01 | 2.755E−01 | 1.818E−01 |
| . . . | . . . | . . . | . . . |

Here, Mean denotes the mean value, Min the minimum value, Max the maximum value, dev the standard deviation, and Ind a fatigue load indicator. It shall be understood that (as indicated by . . . ), a variety of other data may be included.

In step 304, a training of the machine learning model can be performed using the generated wind power training data sets. Preferably, a portion of the generated wind power training data sets can be used as validation data sets. In an, in particular, conventional manner, a machine learning model in the form of a neural network may preferably be trained. In this context, a wind power training data set may be transformed into a vector, a matrix, and/or a tensor for input.

FIG. 3b shows a diagram of a further embodiment of a method according to the present invention. In order to avoid repetitions, only the differences to the embodiment shown in FIG. 3a are described below, and reference is otherwise made to the previous descriptions.

In order to provide the at least one load data set, in step 306 a measuring of at least one load parameter of the reference wind turbine (i.e., of at least one component of the reference wind turbine) can be performed during a measurement period (preferably at least 6 months).

In particular, at least an almost continuous measurement and thus monitoring can be performed. As has been already described, the measuring of the at least one load parameter can be performed, in particular, in accordance with the IEC 61400-13 standard [2]. Preferably, the load parameter values can be obtained for a plurality of load parameters of a plurality of components of the reference wind turbine.

In step 307, which may be performed at least partially in parallel with step 305, a converting of the at least one measured load parameter value of the reference wind turbine may be performed into at least one fatigue load indicator. Preferably, all load parameter values may be converted. The converting may, in particular, be based on a rainflow counting method. It is particularly preferred that the converting of the at least one measured load parameter value of the reference wind turbine into at least one fatigue load indicator be performed in accordance with the ASTM E1049-85(2017) standard.

In step 307, the load data sets may also be formed. For this purpose, the fatigue load indicators (in particular, corresponding to the timestamp with which the load parameter values (respectively the corresponding sample values) are provided) may be divided into a plurality of load data sets each having a load data time duration as has been previously described. The load data time duration may preferably correspond to the operating data time duration. In particular, an operating data time duration is assigned to each provided (SCADA) operating data set.

The operating parameter values of the at least one operating parameter can be detected during the measurement duration and, in particular, provided (in a known manner) in the form of operating data sets in step 305 (see, e.g., Table 1 and/or 2).

In step 308, a generating of a plurality of wind power training data sets (see Table 4) may be performed for training a machine learning model by synchronously assigning a respective operating data set to a respective load data set, as has been previously described.

In step 309, preprocessing respectively pre-treatment of the generated wind power training data sets may be performed. For example, invalid values and/or indicators may be removed. Feature selection may also be performed in step 309 in the manner described above. Examples of this include sequential feature selection (e.g., Ferri, F. J., & Pudil, Pavel, & Hatef, M. (2001). Comparative Study of Techniques for Large-Scale Feature Selection. Pattern Recognition in Practice, IV: Multiple Paradigms, Comparative Studies and Hybrid Systems. 16. 10.1016/B978-0-444-81892-8.50040-7), recursive feature selection (e.g., Guyon, I, J Weston, S Barnhill, and V Vapnik. 2002. “Gene Selection for Cancer Classification Using Support Vector Machines.” Machine Learning 46 (1): 389-422), Linear regression with L1 regularization (Lasso) and/or Bayesian LASSO (e.g., Trevor Park & George Casella (2008) The Bayesian Lasso, Journal of the American Statistical Association, 103:482, 681-686, DOI: 10.1198/016214508000000337).

In step 310, in particular, a dividing of the generated wind power training data sets is performed into training data sets (e.g., 80%) and validation data sets (e.g., 20%). In addition and in particular, a transforming of the wind power training data sets is performed into data representations suitable as input for the machine learning model to be trained, i.e., representations that may depend (in a known manner) on the machine learning model to be trained. Preferably, a wind power training data set is transformed into a vector, a matrix, and/or a tensor.

In step 311, a training respectively learning of the machine learning model is performed during a training period. Preferably, a neural network can be trained. Preferably, a so-called supervised training respectively learning is performed using the training data sets and the validation data sets.

During the training period, a model for estimating the aleatory and/or epistemic uncertainties may be applied, wherein the estimation may be achieved by applying at least one machine learning method. During the training period respectively during the training process, at least one regularization technique may be applied. This can at least reduce the risk of overfitting. The at least one regularization technique (in particular, the at least one machine learning method) may be selected, in particular, from the group comprising:
a. linear Bayesian regression (also referred to as Bayesian linear regression),
b. Bayesian neural network with concrete dropout (also referred to as Bayesian neural network by concrete dropout) or Bayesian neural network with variational inference (Bayesian neural network by Variational Inference),
c. adaptive Bayesian spline regression (also known as Bayesian adaptive spline regression).

The mentioned methods already comprise an estimation of aleatory and/or epistemic uncertainties. In particular, Bayesian neural networks allow for the representation of heteroscedastic uncertainties, i.e., uncertainties whose magnitude depends on the expected value of the estimated target variable (plant condition).

Alternatively (or additionally), these can be determined during the training period respectively during the training process using other methods (in specifically bootstrapping).

After training, in step 312, a trained machine learning model can be made available for further use.

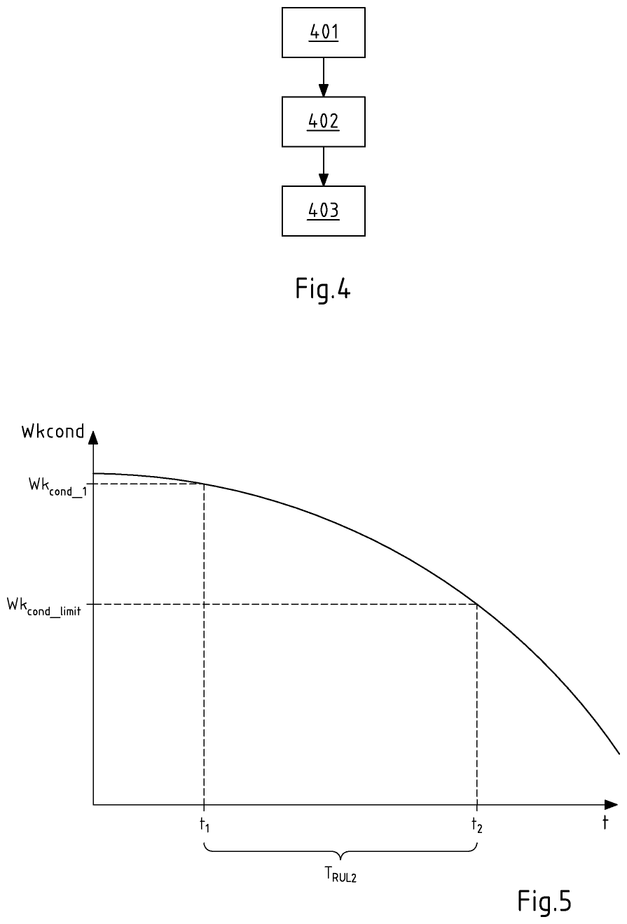

FIG. 4 shows a diagram of an embodiment of a method for using a machine learning model that has been trained according to the present invention, for example, in accordance with the embodiment shown in FIGS. 3a and/or 3b. The method can be performed respectively used, in particular, in step 201 of FIG. 2.

In a first step 401, an inputting of at least one operating data set (preferably a plurality of operating data sets) of a first wind turbine may be performed into the machine learning model. Preferably, the operating data sets detected during a defined period (in particular, at least 2 months, preferably at least 3 months (and, for example, at most 24 months)) may be input. The first wind turbine is preferably of the same, or at least a similar, type as the reference wind turbine. Preferably, the first wind turbine may additionally be part of the same wind farm as the reference wind turbine (see, e.g., FIG. 1). It shall be understood that the first wind turbine may also originate from a different wind farm.

In step 402, an outputting by the machine learning model may be performed of at least one plant condition data set. The plant condition data set may, for example, contain at least one determined fatigue load indicator for the first wind turbine. It shall be understood that another load parameter indicator may also be output.

In step 403, a determining of the actual remaining service life time (RUL) of the first wind turbine may be performed based on the at least one output plant condition data set of the first wind turbine. This includes, in particular, determining, in particular, estimating, the actual RUL of at least one component of the first wind turbine.

In particular, by training a machine learning model using load data and operating data from a reference wind turbine to identify patterns in this data and “store” them accordingly in the trained machine learning model, the condition respectively state of a first wind turbine can be determined, in particular, estimated, with a high degree of reliability solely on the basis of the operating data of that first wind turbine (i.e., without an actual measurement of a load parameter) using the trained machine learning model. As has been previously described, the condition of the wind turbine comprises the condition of one (or more) structural component(s) of the wind turbine.

FIG. 5 shows an example plant condition diagram, with the help of which, in particular, the actual remaining service life time can be determined, in particular, estimated.

The y-axis represents the plant condition WK_{cond} of the wind turbine respectively the component condition WK_{cond} of a structural component of the wind turbine, and the x-axis represents time t.

Initially, it can be assumed that at the (current) time t₁, the (current) plant condition is WK_{cond_1}. This can be determined, in particular, according to the method shown in FIG. 4.

The defined plant condition threshold WK_{cond_limit} may be predefined. Then, using models as described, the time t₂ can be determined. The time t₂ is, in particular, the time from which the wind turbine is expected to no longer be able to continue operating (for safety reasons). Then the actual RUL respectively T_{RUL} can generally be calculated as follows: T_{RUL}=t₂−t₁.

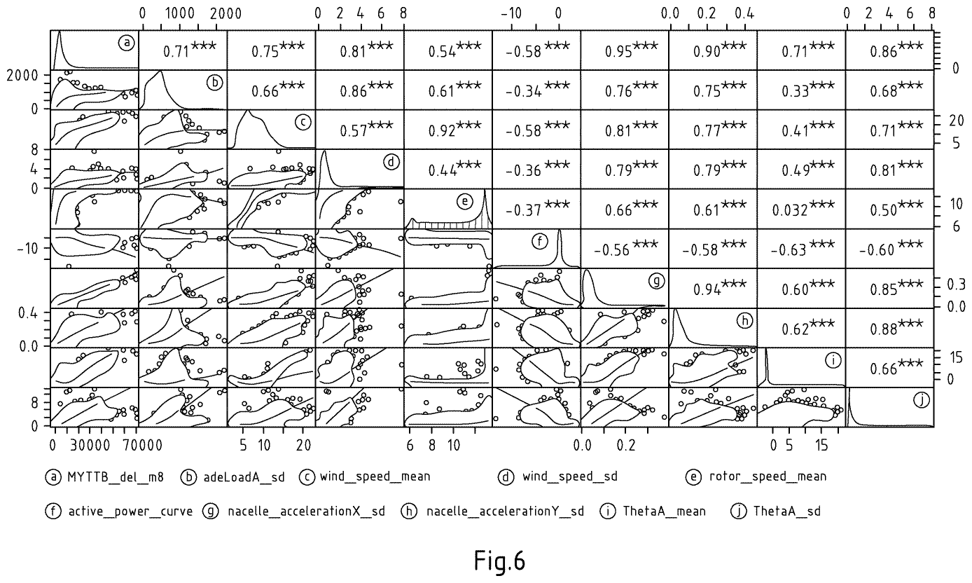

FIG. 6 shows an exemplary diagram illustrating the testing of collinearity by correlation, as can be performed, for example, in step 309.

As can be seen, in particular, from FIG. 6, the correlations (e.g., expressed by the Pearson correlation coefficient in the interval [−1 . . . , 1]) of the operating parameters intended for use are calculated among themselves. Operating parameters with a high correlation coefficient (typically >=0.8 to 0.9 or <=−0.8 to −0.9) are referred to as collinear and should not be used together for training machine learning methods.

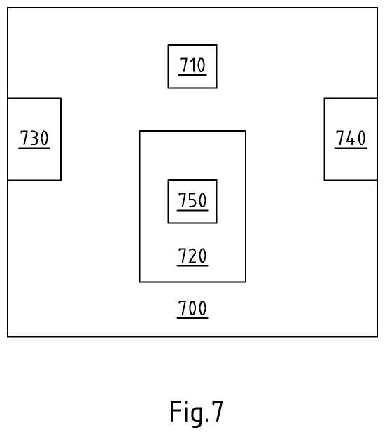

FIG. 7 shows a schematic view of an embodiment of a computing device 700 according to the present invention. The computing device 700 comprises at least one processor (e.g., microprocessor, DSP, FPGA, and/or the like) and at least one data storage 720 containing computer program code. In particular, the data storage 720 contains a computer program corresponding to the (computer-implemented) method of FIG. 2 and the machine learning model 750 that has been trained or is yet to be trained.

Furthermore, at least one communication interface 730 and/or at least one user interface 740 is provided, configured for inputting and/or outputting data, such as operating data sets, training data sets, and/or plant condition data sets.

The data storage 720 and the processor 710 may be configured such that the computing device 700 is caused to generate at least one plant condition data set based on at least one provided operating data set and at least partially using a machine learning model 750, which, for example, was trained according to the embodiment shown in FIG. 3a and/or FIG. 3b.

In particular, the data storage 720 and the processor 710 may be configured such that the computing device 700 is caused to perform at least steps 201, 202, 203, and preferably 204.

### LIST OF REFERENCE NUMERALS

100 Wind farm
102 Reference wind turbine
104 First wind turbine
106 Control device
108 Control module
110 Communication network
112 Sensor arrangement
700 Computing device
710 Processor
720 Data storage
730 Communication interface
740 User interface
750 Model

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A computer-implemented method for a wind farm, comprising:
determining an actual remaining service life time of a first wind turbine of the wind farm based on a model of at least one reference wind turbine and on at least one first operating data set of the first wind turbine,
comparing the determined actual remaining service life time of the first wind turbine with a predefined remaining service life time of the first wind turbine, and
performing a performance adjustment of a predefined performance framework of the first wind turbine for a defined future period such that an alignment of the actual remaining service life time of the first wind turbine is effected with the predefined remaining service life time of the first wind turbine upon a determining of a predefinable deviation between the actual remaining service life time of the first wind turbine and the predefined remaining service life time of the first wind turbine.

2. The method according to claim 1, wherein performing a performance adjustment of a predefined performance framework of the first wind turbine for a defined future period comprises:
increasing at least one permissible performance parameter limit value of the performance framework upon determining that the actual remaining service life time of the first wind turbine is greater than the predefined remaining service life time of the first wind turbine by a predefinable deviation.

3. The method according to claim 1, wherein
at least upon an expiration of the defined future period, the method comprises:
redetermining the actual remaining service life time of the first wind turbine based on the model of the reference wind turbine and at least a second operating data set for the first wind turbine detected during the defined future period,
comparing the re-determined actual remaining service life time of the first wind turbine with the predefined remaining service life time of the first wind turbine, and
performing a further performance adjustment of a predefined performance framework of the first wind turbine for a further defined future period such that an alignment of the actual remaining service life time of the first wind turbine is effected with the predefined remaining service life time of the first wind turbine upon a redetermining of a predefinable deviation between the redetermined actual remaining service life time of the first wind turbine and the predefined remaining service life time of the first wind turbine and/or upon a determining of a predefinable match between the redetermined actual remaining service life time of the first wind turbine and the predefined remaining service life time of the first wind turbine.

4. The method according to claim 1, wherein the method further comprises:
performing the method for a plurality of wind turbines in the wind farm, and
performing a respective performance adjustment of a predefined respective performance framework of the respective wind turbine for a defined future period such that an alignment of the actual respective remaining service life time of the respective wind turbine and the respective remaining service life time of the respective wind turbine and an alignment of the respective remaining service life times with one another is effected upon a determining of at least one predefinable deviation between the respective actual remaining service life time of the respective wind turbine and the respective predefined remaining service life time of the respective wind turbine.

5. The method according to claim 1, wherein the method further comprises:
extending the predefined remaining service life time of the first wind turbine upon a determining that the actual remaining service life time of the first wind turbine is greater than the predefined remaining service life time of the first wind turbine by a predefinable deviation.

6. The method according to claim 1, wherein determining the actual remaining service life time of a first wind turbine comprises using a machine learning model of the reference wind turbine,
wherein training the machine learning model of the reference wind turbine comprises:
providing a plurality of operating data sets for the reference wind turbine,
providing a plurality of load data sets for the reference wind turbine, wherein a load data set is based on at least one load parameter measured at the reference wind turbine, and
generating a plurality of wind power training data sets for training a machine learning model by synchronously assigning a respective operating data set with a respective load data set.

7. The method according to claim 6, wherein
the machine learning model is trained with the generated wind power training data sets during a training period,
and/or
a portion of the generated wind power training data sets is used as validation data sets during a training period.

8. The method according to claim 6, wherein
a provided operating data set contains at least one operating parameter of the reference wind turbine,
wherein the at least one operating parameter is selected from the group comprising:
tower top acceleration,
pitch angle,
pitch rate,
rotor speed,
electrical power,
nacelle wind speed.

9. The method according to claim 6, wherein
a provided load data set is based on at least one measured load parameter of the reference wind turbine,
wherein the load parameter is selected from the group comprising:
blade root load parameter,
rotor load parameter,
tower load parameter,
tower torsion parameter,
tower top moment parameter.

10. The method according to claim 6, wherein the method comprises:
measuring the at least one load parameter of the reference wind turbine.

11. The method according to claim 6, wherein the method comprises:
measuring the at least one load parameter of the reference wind turbine during a measurement period, and
detecting the operating data parameter values of the reference wind turbine during the measurement period.

12. The method according to claim 6, wherein determining the actual remaining service life time of the first wind turbine further comprises:
inputting the at least one first operating data set of the first wind turbine into the machine learning model, and
outputting, by means of the machine learning model, at least one plant condition data set of the first wind turbine.

13. The method according to claim 12, wherein
the first wind turbine is a wind turbine type that is identical to the wind turbine type of the reference wind turbine
and/or
the first wind turbine and the reference wind turbine are part of the same wind farm.

14. The method according to claim 12, wherein the method comprises:
determining the actual remaining lifetime of the first wind turbine based on the at least one plant condition data set of the first wind turbine.

15. A computing device comprising at least one data storage device containing computer program code, and at least one processor, wherein the data storage device and the processor are configured such that the computing device is caused to perform the method according to claim 1.

16. A wind farm, comprising:
at least one computing device according to claim 15, and
at least one first wind turbine.

17. The wind farm according to claim 16, wherein
the wind farm is an offshore wind farm.

18. The method according to claim 6, wherein
an operating data set, as an operating parameter value of an operating parameter, comprises at least one operating parameter value selected from the group, comprising:
the maximum operating parameter value detected during the operating data period,
the minimum operating parameter value detected during the operating data period,
average operating parameter value determined from the operating parameter values detected during the operating data period,
standard deviation determined from the operating parameter values detected during the operating data period.

19. The method according to claim 6, wherein
a load parameter value is provided as the load parameter value of a load parameter, selected from the group comprising:
maximum load parameter value measured during the load data period,
minimum operating parameter value measured during the load data period,
average load parameter value determined from the load parameter values measured during the load data period,
standard deviation determined from the load parameter values measured during the load data period.

20. The method according to claim 10, wherein
wherein the measuring of the at least one load parameter is performed in accordance with the IEC 61400-13 standard [2].

21. The method according to claim 11, wherein
wherein the measurement period is at least 3 months.

22. The method according to claim 21, wherein
the measurement period is at least 6 months.
